(19) United States
(12) Patent Application Publication
(10) Pub. No.: US 2006/0005209 A1
(43) Pub. Date: Jan. 5, 2006

(54) Disk changer devices

(75) Inventors: Ching-Mei Chiang, Tucheng City (TW); Thomas Lee, Hsinchu City (TW); Show Hsiung Lin, Tucheng City (TW); Yu-Chi Lin, Tucheng City (TW); Guang-Chyan Fang, Hsinchu City (TW); Long-Der Chen, Hsinchu City (TW)

Correspondence Address: BIRCH STEWART KOLASCH & BIRCH, PO BOX 747, FALLS CHURCH, VA, 22040-0747, US

(73) Assignee: YUNG-TANG SCIENCE & TECHNOLOGY INDUSTRY CO., LTD.

(21) Appl. No.: 11/081,692

(22) Filed: Mar. 17, 2005

(30) Foreign Application Priority Data
Jun. 30, 2004 (TW) 93119480

(51) Int. Cl. G11B 17/03

(52) U.S. Cl. 720/600

(57) ABSTRACT

Disk changer devices and correlated disk acquisition procedures and disk management system. In the disk changer devices, an interface unit is coupled to a host system, at least one disk storage unit stores a plurality of disks, and a control unit is coupled to the interface unit. A disk acquisition unit is coupled to the control unit, and comprises a gripper retrieving a desired disk from the disk storage unit, a first driver moving the gripper along a vertical direction, a second driver moving the gripper along a horizontal direction, and a disk push unit comprising at least one disk push rod, pushing the desired disk to the gripper from the disk storage unit, wherein the control unit drivers the gripper to retrieve the desired disk and deliver it to a disk processing unit, according to a command from the host system.

### BACKGROUND

The invention relates to changer devices, and more particularly, to disk changer devices.

Recently, as disks are widely used, management and access of disks is important for users. Thus, there is a need for an apparatus storing a plurality of disks, providing access thereto quickly without changing disks manually.

### SUMMARY

Embodiments of a disk change device comprises an interface unit coupled to a host system, in which at least one disk storage unit stores a plurality of disks and a control unit is coupled to the interface unit. A disk acquisition unit is coupled to the control unit, and comprises a gripper removing a desired disk from the disk storage unit, a first driver moving the gripper along a vertical direction, a second driver moving the gripper along a horizontal direction, and a disk push unit comprising at least one disk push rod, pushing the desired disk to the gripper from the disk storage unit, wherein the control unit drivers the gripper to retrieve the desired disk and deliver to a disk processing unit, according to a command from the host system.

Also disclosed are embodiments of a disk acquisition procedure, in which location of a desired disk in the disk storage unit is obtained according to a command from the host system. A corresponding vertical distance, a corresponding horizontal direction and a corresponding horizontal distance are obtained according to the location of the desired disk. The first driver and the second driver are driven to move the gripper to the location of the desired disk according to the corresponding vertical distance, the corresponding horizontal direction and the corresponding horizontal distance. The disk push unit is activated to push the desired disk to an opening of the gripper from the disk storage unit. Finally, the desired disk is retrieved and delivered to the disk processing unit.

Also disclosed are embodiments of a recovery procedure for abnormal power-down, in which a gripper's home position is detected. A normal initial procedure is executed when the gripper is in a home position, and whether the gripper is activated is detected when the gripper is not in the home position. A homing procedure and the normal initial procedure are executed when the disk push unit is activated. The home procedure comprises, opening the gripper, driving the second driver to move the gripper to a central position, closing the gripper, and moving the gripper to the home position. Whether a disk is present in the gripper is detected when the disk push unit is not activated. The disk is located to a backup slot in the disk storage unit and the homing procedure and the normal initial procedure are executed when the disk is held by the gripper. The gripper is moved to the home position and the normal initial procedure is executed when no disk is held by the gripper.

### DESCRIPTION OF THE DRAWINGS

The invention can be more fully understood by the subsequent detailed description and examples with reference made to the accompanying drawings, wherein:

FIG. 1 is a block diagram of an exemplary embodiment of a disk changer device;

FIGS. 2A and 2B are structural diagrams of exemplary embodiment of a disk changer device;

FIG. 3A shows an example of a gripper;

FIG. 3B is a structural diagram of an example of a gripper;

FIG. 4 is a flowchart illustrating an embodiment of a disk acquisition procedure.

FIG. 5 is a diagram illustrating the disk acquisition procedure shown in FIG. 4;

FIG. 6 is a detailed flowchart of the embodiment of a disk acquisition procedure;

FIGS. 7A˜7C are diagrams illustrating the disk acquisition procedure shown in FIG. 6; and

FIG. 8 is a flowchart of an embodiment of a recovery procedure of abnormal power-down.

### DETAILED DESCRIPTION

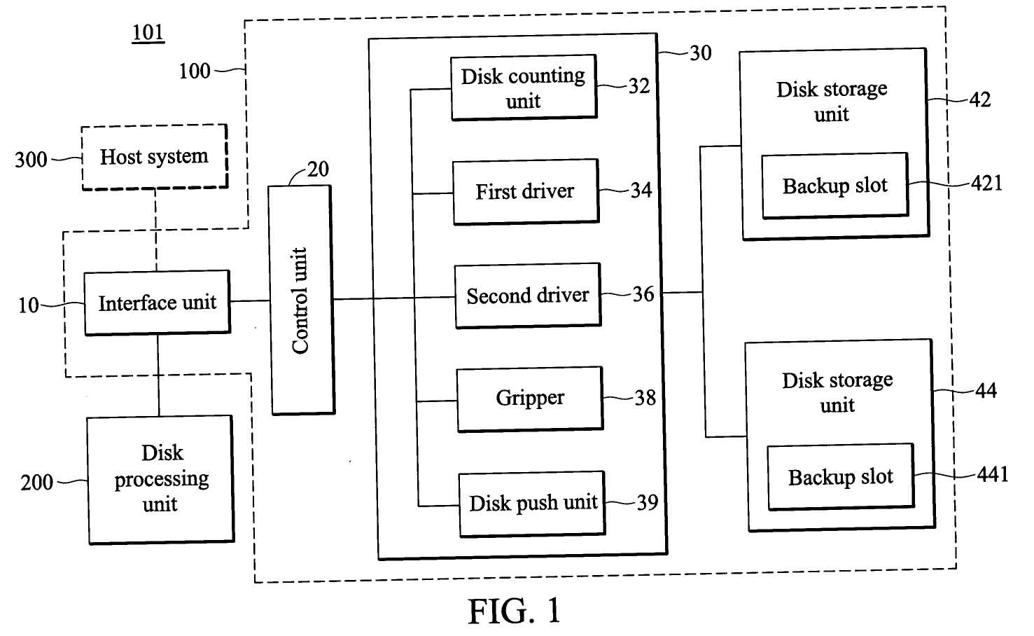

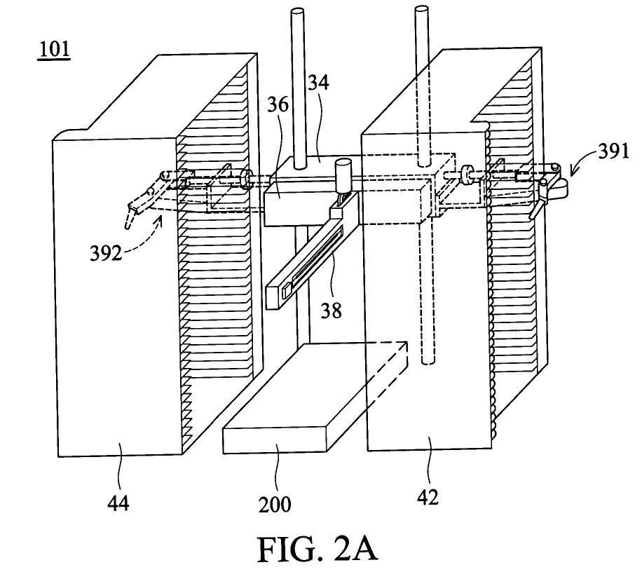

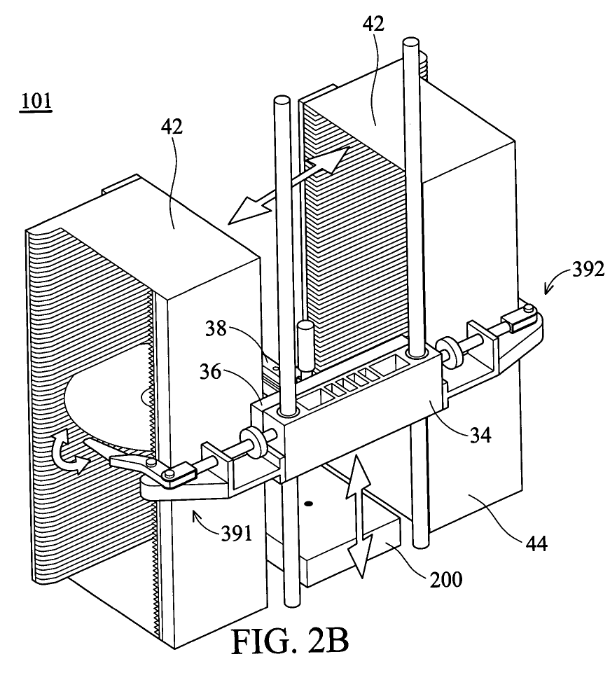

FIGS. 1, 2A and 2B are diagrams showing an exemplary embodiment of a disk changer device. The disk management system comprises a disk changer device 100 and a disk processing unit 200. The disk changer device 100 acquires a desired disk and delivers it to the disk processing unit 200 according to a command from an external host system 300. For example, the disk changer device 100 can be coupled to the host system via a universal serial bus (USB). The disk processing unit 200 can be a CD-ROM, a DVD-ROM, a CD-RW, a DVD+RW or the like to access or burn disks. The disks can be compact disks, optical disks and the like.

The disk changer device 100 comprises an interface unit 10, a control unit 20, a disk acquisition unit 30 and disk storage units 42 and 44. The interface unit 10 is coupled to the host system 300, the control unit 20 and the disk processing unit 200, in which the interface unit 10 is coupled to the host system through universal serial bus (USB) and coupled to the disk processing unit 200 through an integrated device electronics (IDE) interface. The disk storage units 42 and 44 shown in FIG. 2A each comprise a plurality of slots storing disks and having a backup slot (441 and 442) storing disks during recovery from power-down. The interface unit 10 can be a PL-2507 control chip and the disk storage units 42 and 44 can be disk racks.

The control unit 20 is coupled between the interface unit 10 and the disk acquisition unit 30, and, can for example, be a microprocessor or a processing unit, calculating location of a desired disk and obtaining a vertical distance, a horizontal direction (left or right) and a horizontal direction according to a command from the host system 300.

The disk acquisition unit 30 is coupled to the control unit 20 to deliver disks between the disk storage units 42 and 44 and the disk processing unit 200, and comprises a disk counting unit 32, a first driver 34, a second driver 36, a gripper 38 and a disk push unit 39. The first driver 34 drives the gripper 38 along the vertical direction, and the second driver 36 drives the gripper 38 along the horizontal direction. For example, the first driver 34 and the second driver 36 can be step motors, driving the gripper 38 along the vertical direction and the horizontal direction respectively. The gripper 38 retrieves a desired disk from the disk storage units 42 and 44, and the disk push unit 39, comprising two disk push rods 391 and 392 as shown in FIG. 2A, pushes the desired disks to the gripper 38 from the disk storage units 42 or 44.

The control unit 20 drivers the disk acquisition unit 30 to acquire a desired disk and delivers it to the disk processing unit 200. For example, the control unit 20 drives the first and second drivers 34 and 36 to move the gripper 38 to the location of the desired disk, activates the disk push unit 39 to push the desired disk to the gripper 38 from the disk storage unit, and drives the first and second drivers to deliver the desired disk to the disk processing unit 200. The disk counting unit 32 counts the disks in the disk storage units 42 and 44. For example, the disk counting unit 32 can comprise two disk counters to count the disks in the disk storage units 42 and 44 respectively. Each disk count can include an emitter and a receiver disposed on the gripper 38 and the disk push rods 391 and 392 respectively, such that a disk is determined to be present when the receiver cannot receive the signal from the corresponding emitter.

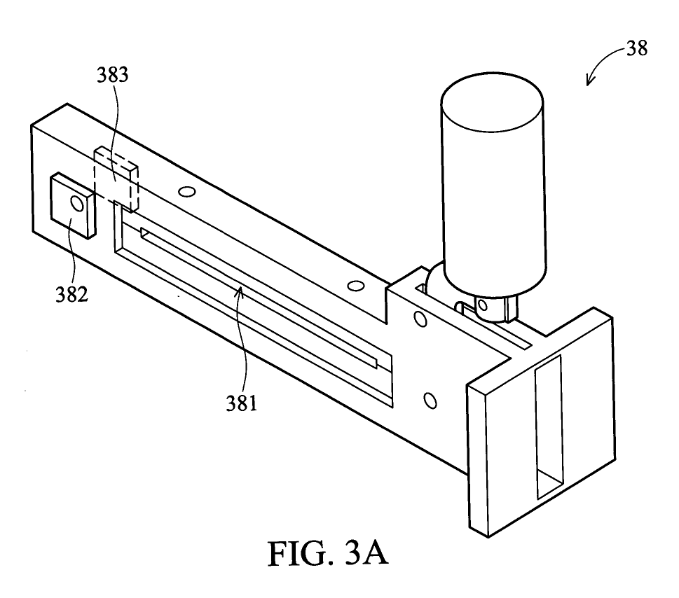

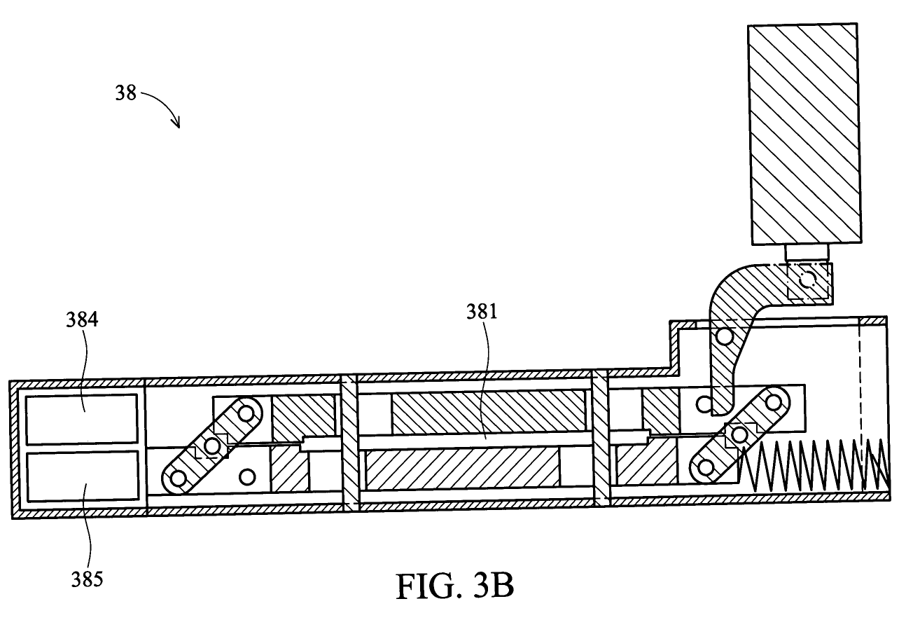

As shown in FIG. 3A, the gripper 38 comprises an opening 381 to retrieve disks, and the sensors 382 and 383 are disposed on two sides of the gripper 38 to detect whether the disk is held by the gripper 38. As shown in FIG. 3B, the sensors 384 and 385 detect whether the opening 381 is closed, in which the sensor 384 is activated when the opening 381 is opened and the sensor 385 is activated when the opening 381 is closed.

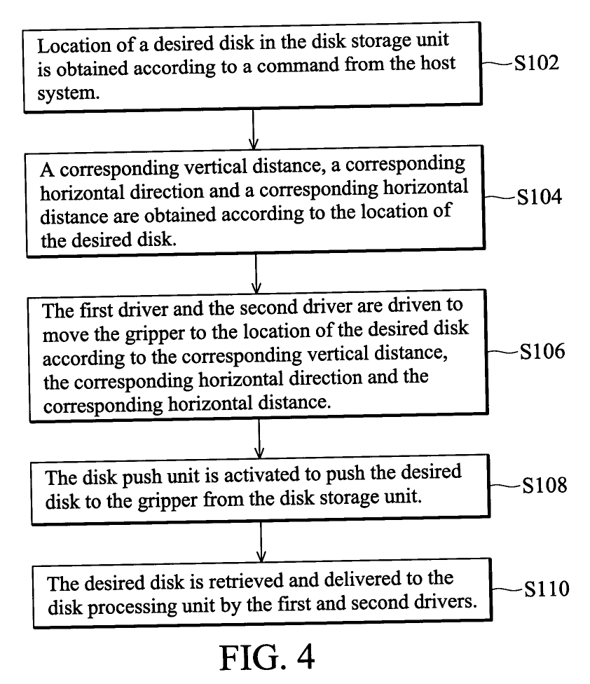

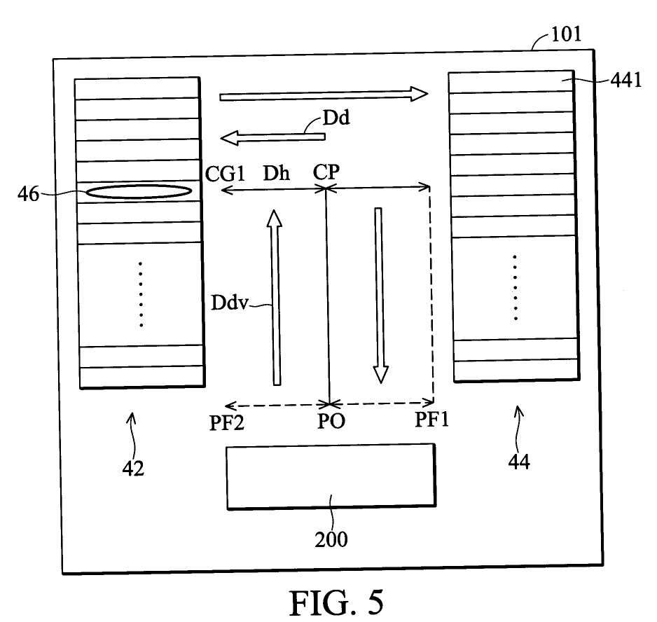

FIG. 4 is a flowchart of an embodiment of a disk acquisition procedure. FIG. 5 is a diagram of the disk changer device. First, in step S102, the control unit 20 calculates the location of the desired disk, for example, disk 46, and obtains a corresponding vertical distance Dv, a corresponding horizontal direction Dd and a corresponding distance Dh accordingly (in step S104). In step S106, the control unit 20 drives the first driver and the second driver 34 and 36 to move the gripper 38 to the location of the desired disk 46 according to the corresponding vertical distance Dv, the corresponding horizontal direction Dd and the corresponding distance Dh. The control unit 20 activates the gripper 38 to open the opening thereof before the gripper 38 reaches the desired disk 46. Then, in step S108, the control unit 20 activates the disk push unit 39 to push the desired disk 46 to the opening of the gripper 38 from the disk storage unit 42. Finally, in step S110, the control unit 20 activates the gripper 38 to retrieve the desired disk 46 and delivers the desired disk 46 to the disk processing unit 200 by the first and second drivers 34 and 36.

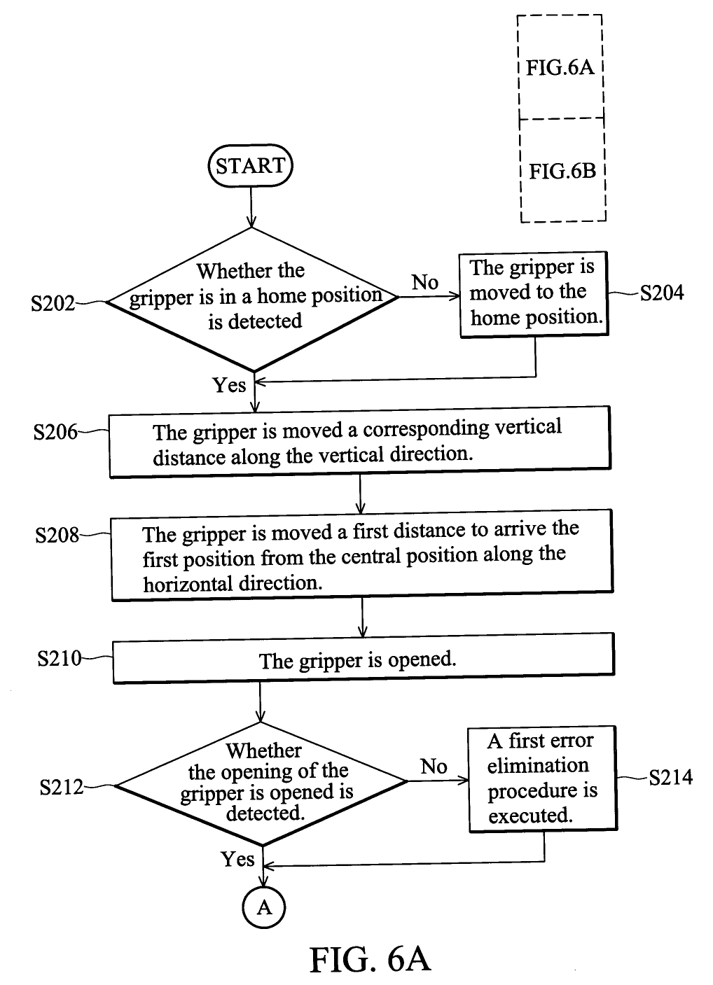

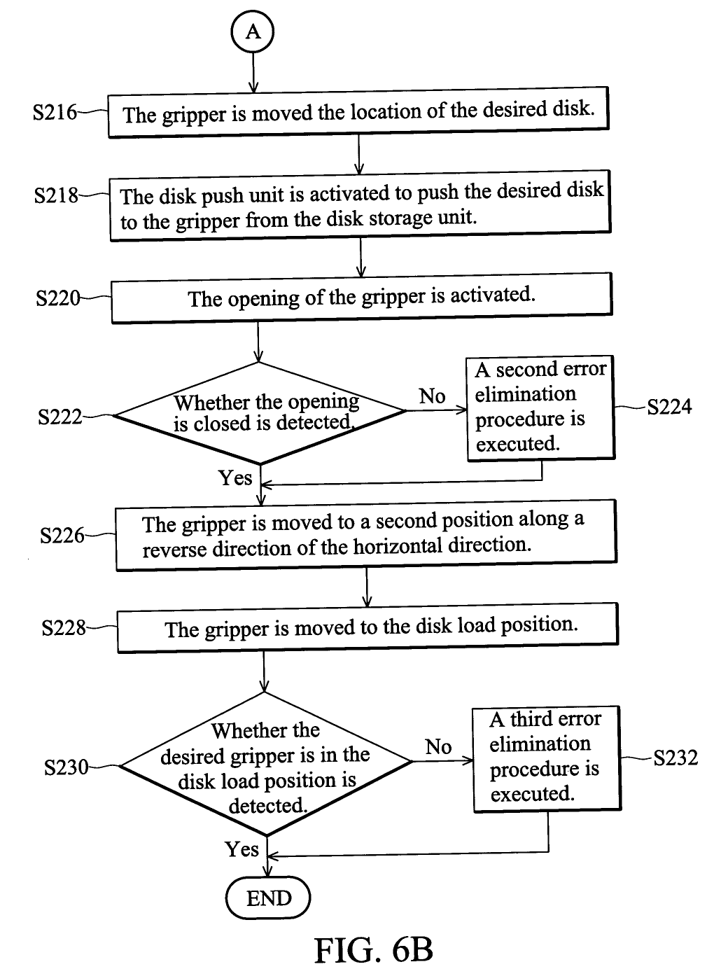

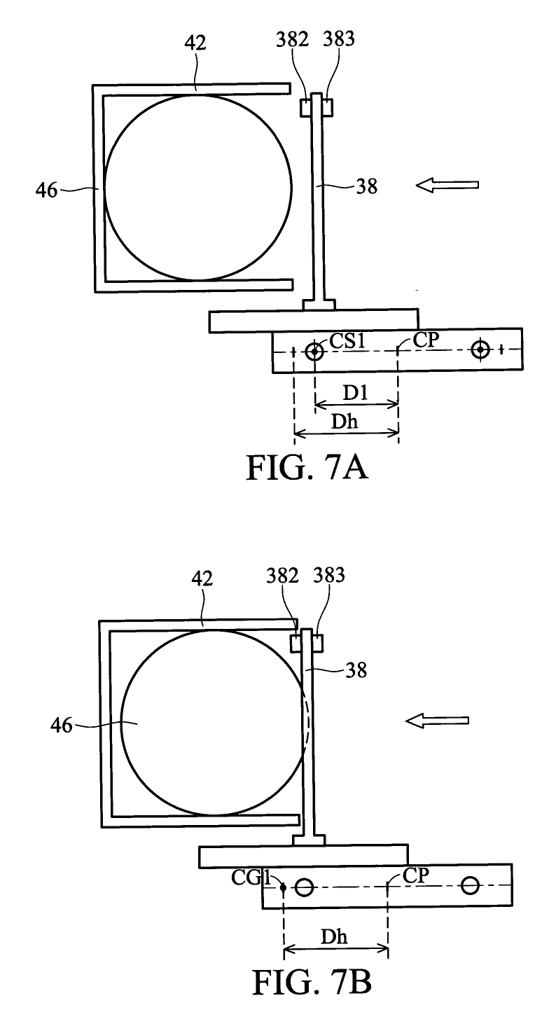

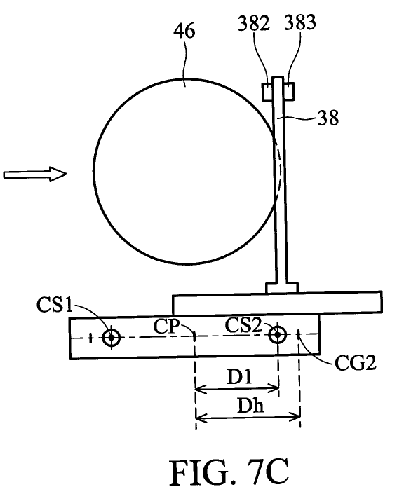

FIG. 6 is a flowchart illustrating steps S106˜S110 in FIG. 4 in more detail. In step S202, the control unit 20 detects whether the gripper 38 is in a home position P0. If not, step S204 is executed, the first driver and second driver are driven to move the gripper 38 to the home position P0. If the gripper 38 is in the home position P0, the control unit 20 driver the first driver 34 to move the gripper 38 a corresponding vertical distance Dv along the vertical direction Ddv in step S206. In step S208, the control unit 20 drives the second driver to move the gripper 38 a first distance D1 to reach the first position CS1 from the central position P0 along the horizontal direction Dd. In step S210, the opening 381 is opened when the gripper 38 reaches the first position CS1, as shown in FIG. 7A.

Then, in step S212, the control unit 20 detects whether the opening 381 is opened by the sensor 384 in the gripper 38. If the opening 381 is not opened, a first error elimination procedure is executed in step S214. If the opening 381 is opened, the control unit 20 drives the second driver 36 to move the gripper 38 the horizontal distance Dh from the central position P0 along the horizontal direction and to reach the location CG1 of the desired disk 46 in step 216. Then, in step S218, the control unit 20 activates the disk push unit 39 to push the desired disk 46 to the opening 381 from the disk storage unit 42. In this embodiment, the control unit 20 activates the disk push rod 391 of the disk push unit 39 to push the desired disk 46 to the opening 381 of the gripper 38. In step S220, the control unit 20 activates the gripper 38 to close the opening 381, as shown in FIG. 7B. In step S222, the control unit 20 detects whether the opening 381 is closed by the sensor 385 of the gripper 38. If the opening 381 is not closed, a second error elimination procedure is executed in step S224. If the opening 381 is closed, in step S226, the control unit 20 drives the second driver to move the gripper 38 to a second position CS2 along a reverse direction of the horizontal direction as shown in FIG. 7C.

In step S228, the control unit 20 drives the first driver to move the gripper 38 to the disk load position PF1 such that the desired disk 46 can be processed by the disk processing unit 200 as shown in FIG. 5. In step S230, the control unit 20 detects whether the desired gripper 38 is at the disk load position PF1. If so, the disk acquisition procedure is complete. If not, a third error elimination procedure is executed in step S232. In the embodiments, the horizontal direction is left and the disk load position is PF1 because the desired disk is in the disk storage unit 42. On the contrary, the horizontal direction is right and the disk load position is PF2 when the desired disk is in the disk storage unit 44. Thus, the invention can acquire a desired disk from the disk storage units for data read or burning without changing disks manually according to the command from the external host system.

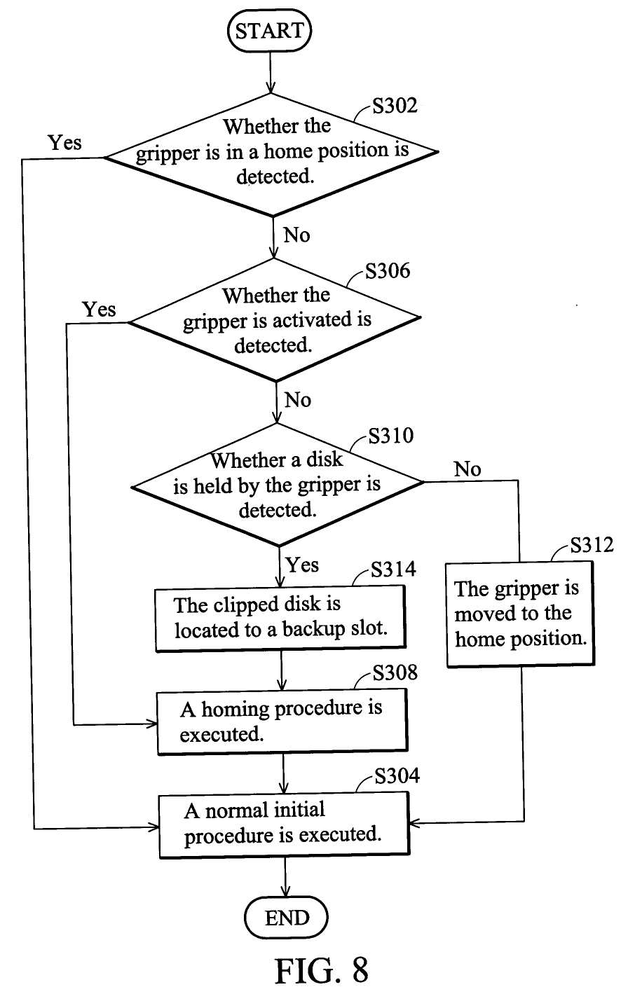

FIG. 8 is a flowchart of an embodiment of a recovery procedure of abnormal power-off. In step S302, the control unit 20 detects whether the gripper 38 is in the home position P0 as shown in FIG. 5. If so, a normal initial procedure is executed and the recovery procedure is compete in step S304. If not, the control unit 20 detects whether the disk push unit 39 is activated in step S306.

If the disk push unit 39 is activated in step S306, the control unit 20 executes a homing procedure and the normal initial procedure in step S304 and the recovery procedure is complete. In the homing procedure, the opening 381 of gripper 38 is opened, the second driver 36 is driven to move the gripper 38 to the central position CP, the opening 381 of the gripper 38 is closed, and the gripper 38 is moved to the home position P0.

If the disk push unit 39 is not activated in step S306, the control unit 20 detects whether the gripper holds a disk in step S310. If not, the control unit 20 drives the first and second drivers to move the gripper 38 to the home position P0. Then, a normal initial procedure in step S304 is executed and the recovery procedure is complete.

If a disk is held by the gripper 38, the control unit 20 drives the first and second drivers to move the clipped disk to backup slots 441 or 442 in the disk storage units 42 and 44 in step S314. Then, the homing procedure in step S308 and the normal initial procedure in step S304 are executed and the recovery procedure is complete.

The invention moves the gripper to the home position and the held disk to the backup slot in order to prevent abnormal operation after the disk changer device is abnormally powered down.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A disk changer device, comprising:
an interface unit coupled to a host system;
at least one disk storage unit storing a plurality of disks;
a control unit coupled to the interface unit; and
a disk acquisition unit coupled to the control unit, comprising:
a gripper retrieving a desired disk from the disk storage unit;
a first driver moving the gripper along a vertical direction;
a second driver moving the gripper along a horizontal direction; and
a disk push unit comprising at least one disk push rod, pushing the desired disk to the gripper from the disk storage unit, wherein the control unit drives the disk acquisition unit to retrieve the desired disk and deliver to a disk processing unit, according to a command from the host system.

2. The disk changer device as claimed in claim 1, wherein the control unit drives the first driver and the second driver to move the gripper to a location of the desired disk, activates the disk push unit to push the desired disk to the gripper from the disk storage unit, such that the desired disk is clipped by the gripper, and drives the first driver and the second driver to deliver the desired disk to the disk processing unit.

3. The disk changer device as claimed in claim 2, wherein the interface unit is coupled to the disk processing unit, the host system and the control unit.

4. The disk changer device as claimed in claim 3, wherein the interface unit is coupled to the host system by a universal serial bus(USB).

5. The disk changer device as claimed in claim 4, further comprising a disk counting unit disposed in the disk acquisition unit, counting the disks in the disk storage unit.

6. The disk changer device as claimed in claim 5, wherein the first driver and the second driver are step motors.

7. The disk changer device as claimed in claim 5, wherein the disk storage unit is a disk rack.

8. The disk changer device as claimed in claim 7, wherein the interface unit is a PL-2507 control chip.

9. A disk management system, comprising:
a disk processing unit accessing disks; and
a disk changer device as claimed in claim 1, coupled to a host system and the disk processing unit, retrieving a desired disk from the disks stored in the disk storage unit and delivering the desired disk to the disk processing unit, according to a command from the host system.

10. The disk management system as claimed in claim 9, wherein the disk processing unit reads or burns in the disks.

11. The disk management system as claimed in claim 9, wherein the disk processing unit is a CD-ROM, a DVD-ROM, a CD-RW or a DVD+RW.

12. A disk acquisition procedure, applied to the disk changer device as claimed in claim 1, comprising:
obtaining location of a desired disk in the disk storage unit according to a command from the host system;
obtaining a corresponding vertical distance, a corresponding horizontal direction and a corresponding horizontal distance according to the location of the desired disk;
driving the first driver and the second driver to move the gripper to the location of the desired disk according to the corresponding vertical distance, the corresponding horizontal direction and the corresponding horizontal distance;
enabling the disk push unit to push the desired disk to the gripper from the disk storage unit;
retrieving the desired disk; and
delivering the desired disk to the disk processing unit.

13. The disk acquisition procedure as claimed in claim 9, further comprising opening the gripper before the gripper reaches the desired location.

14. The disk acquisition procedure as claimed in claim 9, wherein moving the gripper to the desired location comprises the steps of:
driving the first driver to move the gripper the corresponding vertical distance along the vertical direction;
driving the second driver to move the gripper along the horizontal direction;
opening the gripper when the gripper is moved to a first predetermined location along the horizontal direction; and
closing the gripper when the gripper reaches the location of the desired disk along the horizontal direction.

15. The disk acquisition procedure as claimed in claim 9, wherein delivery of the desired disk to the disk processing unit comprises the steps of:
driving the second driver to move the gripper to a second predetermined disposition along a reverse direction of the horizontal direction; and
driving the first driver to move the gripper to a disk loading position.

16. The disk acquisition procedure as claimed in claim 14, wherein moving the gripper to the location of the desired disk further comprises the steps of:
detecting whether the gripper is in a home position; and
driving the first driver and the second driver to move the gripper to the home position when the gripper is not at the home position.

17. The disk acquisition procedure as claimed in claim 12, wherein the corresponding horizontal distance is a constant distance.

18. A recovery procedure of abnormal power-down, applied to the disk changer device as claimed in claim 1, comprising
detecting whether the gripper is in a home position;
executing a normal initial procedure when the gripper is in the home position;
detecting whether the gripper is activated when the gripper is not at the home position;
executing a homing procedure and the normal initial procedure when the disk push unit is activated,
wherein the home procedure comprises the steps of:
opening the gripper;
driving the second driver to move the gripper to a central position;
closing the gripper; and
moving the gripper to the home position;
detecting whether a disk being retrieved by the gripper when the disk push unit is not activated;
locating the disk to a backup slot in the disk storage rack and executing the homing procedure and the normal initial procedure when the disk is held by the gripper; and
moving the gripper to the home position and executing the normal initial procedure when no disk is held by the gripper.

19. A recovery procedure of abnormal power-down as claimed in claim 18, wherein putting the disk to the backup slot comprises:
driving the second driver to move the gripper to the central position; and
driving the first driver and second driver to move the gripper, delivering the disk to the backup slot.
